(19) United States
(12) Patent Application Publication
(10) Pub. No.: US 2009/0074411 A1
(43) Pub. Date: Mar. 19, 2009

(54) SYSTEM, METHODS, APPARATUSES, AND PROGRAM CODE FOR CAPTURING, STORING, AND RETRIEVING INFORMATION COMMUNICATED IN A NETWORK

(75) Inventors: Marc R. Bernard, Miramar, FL (US); John T. Burch, McLean, VA (US); Joseph D. Kralowetz, Clarksville, MD (US); Douglas F. Ortega, Potomac, MD (US); Michael J. Wurst, Santa Rosa, CA (US)

Correspondence Address: FITZPATRICK CELLA (TELLABS), 30 ROCKEFELLER PLAZA, NEW YORK, NY, 10112-3800, US

(73) Assignee: TELLABS VIENNA, INC., Naperville, IL (US)

(21) Appl. No.: 11/857,658

(22) Filed: Sep. 19, 2007

(51) Int. Cl. H04J 14/00; H04B 10/20

(52) U.S. Cl. 398/58

(57) ABSTRACT

A method, apparatus, system, and computer-readable program, for for capturing communicated information across a network that includes a plurality of nodes. The method includes providing criteria for capturing, in at least a first one of the nodes, information included in at least one communication passing through the at least one first node, capturing, from the at least one communication passing through the at least one first node, information meeting the criteria, and providing the information captured in the capturing to at least a second one of the nodes of the network. According to one embodiment of the invention, the at least one first node includes an Optical Network Terminal (ONT), the at least one second node includes an Element Management System (EMS), and the information includes Ethernet frames. The method further comprises presenting the information to an operator at the EMS, in a decomposed, interpretable format.

### BACKGROUND

1. Field

Example aspects of the present invention relate generally to the retrieval and storage of information such as frames or packets, and more particularly to the retrieval and storage of Ethernet/IP frames and/or other types of information, for diagnostic purposes.

2. Description of the Related Art

There is a growing demand in the industry to find a solution to transmit voice, data, or video from a headend to a subscriber's premises through a fiber optic network all the way into an individual home or business. Such fiber optic networks generally are referred to as fiber-to-the-home (FTTH), fiber-to-the-premises (FTTP), fiber-to-the-business (FTTB), fiber-to-the-node (FTTN), or fiber-to-the-curb (FTTC) networks and the like, depending on the specific application of interest. Such types of networks are also referred to herein generally as “FTTx networks”.

In a FTTx network, equipment at a headend or central office couples the FTTx to external services such as a Public Switched Telephone Network (PSTN) or an external network. Signals received from these services are converted into optical signals and are combined onto a single optical fiber at a plurality of wavelengths, with each wavelength defining a channel within the FTTx network.

In a FTTP network, the optical signals are transmitted through the FTTP network to an optical splitter that splits the optical signals and transmits the individual optical signals over a single optical fiber to a subscriber's premises. At the subscriber's premises, the optical signals are converted into electrical signals using an Optical Network Terminal (ONT). The ONT may split the resultant signals into separate services required by the subscriber such as computer networking (data), telephony and video.

In FTTC and FTTN networks, the optical signal is converted to an electrical signal by either an Optical Network Unit (ONU) (FTTC) or a Remote Terminal (RT) (FTTN), before being provided to a subscriber's premises.

A typical FTTx network often includes one or more Optical Line Terminals (OLTs) which each include one or more Passive Optical Network (PON) cards. Such a typical network is illustrated in FIG. 1. Each OLT typically is communicatively coupled to one or more ONTs (in the case of a FTTP network), or to one or more Optical Network Units (ONUs) (in the case of a FTTC network), via an Optical Distribution Network (ODN). In a FTTP network the ONTs are communicatively coupled to customer premises equipment (CPE) used by end users (e.g., customers or subscribers) of network services. In a FTTC network, the ONUs are communicatively coupled to network terminals (NT), and the NTs are communicatively coupled to CPE. NTs can be, for example, digital subscriber line (DSL) modems, asynchronous DSL (ADSL) modems, very high speed DSL (VDSL) modems, or the like.

In a FTTN network, each OLT typically can be communicatively coupled to one or more RTs. The RTs are communicatively coupled to NTs that are communicatively coupled to CPE.

FTTx networks may operate using, for example, the Open Systems Interconnection (OSI) Reference Model, or a variation thereof. The OSI Model divides protocol functions into a series of layers, wherein each layer employs the functionality of a lower layer and exports functionality to a layer above it. Lower layers typically are implemented using hardware, and higher layers are implemented using software. Layer 7 is an application layer which is an interface that enables a user to access network information through an application, Layer 6 is a presentation layer that converts data to provide a standard interface for Layer 7, using compression, encoding, encryption techniques and the like, and Layer 5 is a session layer which controls communications between computing devices. Layer 4 is a transport layer which provides, for example, flow and error control so that there is reliable and transparent data transfer between end users.

Layer 3 of the OSI Model is a network layer which performs routing functions, delivery of error reports and the like, to enable transfer of variable length data sequences from sources and destinations via one or more networks while maintaining a predetermined quality of service level. The Internet Protocol (IP) is one example of a Layer 3 protocol. Typically, a Layer 3 protocol uses a hierarchical addressing scheme, and routers operate at the layer. Layer 2 is a data link layer providing a protocol to transfer data between network entities, detect and correct errors occurring at Layer 1, and the like. Examples of Layer 2 protocols include Ethernet, HDLC and ADCCP for point-to-point or packet-switched networks, and Aloha for local area networks. In some networks, such as IEEE 802 and FDDI networks, the data link layer may be divided into a Media Access Control (MAC) layer and the IEEE 802.2 Logical Link Control (LLC) layer. Asynchronous transfer mode (ATM), Broadband Passive optical network (BPON), Gigabit PON (GPON), and Ethernet PON (EPON) protocols also are examples of layer 2 protocols. Switches, bridges, and FTTX equipment operate at Layer 2.

Layer 1 is the physical layer which specifies the electrical/physical specifications and operating criteria for network components, such as cable specifications, voltages, pin specifications, and the like. Devices such as, for example, repeaters, hubs, and network adapters are employed in this layer. The layer can establish and terminate connection to a communications interface, convert digital data in user equipment to information signals that can be transmitted over cables or other communication links, and engage in resource sharing operations.

Networks are typically employed to provide one or more services, such as voice, video, or data. Network equipment is designed to support such services, and is optimized to perform one or more functions of the OSI (or a derivative thereof) model. FTTX equipment, for example, is optimized for Layer 2 (transfer of data between network elements), and can be used to transfer data for higher layers to support the end-user services.

Conventional mechanisms exist to capture frames on-demand from local “box” equipment, such as a PC, test equipment, and the like, whereby a user can command an application to send a capture request to a test interface, such as, for example, a LAN interface connected to a local network or the like, and wherein the test interface is capable of monitoring Ethernet traffic. The test interface can then retrieve frames in real-time and send them back to the application, where they are parsed and displayed to the user in a format using software such as, for example, EtherReal software. In one known technique, a PC is connected to an Ethernet hub or bridge, which replicates Ethernet traffic. The PC captures and displays this information using EtherReal software. An example of such a display is shown in FIG. 12, and also can be found at the following webpage: http://www.ethereal.com/distribution/docs/userguide-us.pdf. The user then can employ the displayed information in an attempt to troubleshoot problems between network elements.

Delivery of voice (telephony), video, and data services requires successful communication protocol negotiation at each layer. Troubleshooting each layer can be a challenge (and costly) because it often requires coordination between different pieces of network equipment, technicians, and skill sets. For example, a customer may report to a service provider that there is no operational internet service. A technician familiar with ATM technology might be asked to troubleshoot the access network—Edge Router to OLT to ONT to Broadband Home Router (BHR). A common troubleshooting step is to verify the integrity of the ATM communication path between the Edge Router and the ONT using the OLT/ONT management Operational Support System (OSS). This can be done by requesting the Layer 2 network equipment to perform an ATM F4 or F5 loopback (one device sends a series of known packets, the far end device returns them to the sender, and the sender reports statistics on the quality of the Layer 2 connection). This test can verify that Layer 1 (the physical layer) and Layer 2 (the transport layer) are functioning properly.

If the problem is not isolated at Layer 2, the next step typically would be to verify Layer 3 integrity. A technician familiar with IP (often this is someone different than an ATM technician) might be asked to troubleshoot equipment that optimizes this layer. This equipment is generally different than the access equipment (or a different interface on the Layer 2 equipment), and generally requires different personnel, a different skill set, and different management OSSs to employ the troubleshooting steps.

Typical Layer 3 equipment in FTTX networks may include, for example, Core Routers, Edge Routers, DHCP Servers, ONTs (when configured for routing), Broadband Home Routers, Set Top Boxes and the like; essentially any element with an IP address or that supports IP routing. For example, a Broadband Home Router might be configured to use DHCP. The BHR requests an address from the DHCP Server (located somewhere in the service provider's routed network) using Layer 3 communication protocols. These Layer 3 signaling datagrams are carried across the access network (OLT/ONT) in a Layer 2 payload.

Conventionally, no capability exists to snoop (or capture) this traffic (e.g., Layer 3 information), and present it to a user in simplified format from Layer 2 equipment using the Layer 2 management OSS. Neither does a capability exist to order an existing network element, from across a network, to capture such traffic.

### SUMMARY OF THE INVENTION

The foregoing and other limitations are overcome by a method for capturing communicated information across a network and by an apparatus, system (network), and computer-readable program, that operate in accordance with the method.

According to one example embodiment of the invention, the method includes providing criteria for capturing, in at least a first one of the nodes (also referred to herein as “network elements” or “network components”), information included in at least one communication passing through the at least one first node, capturing, from the at least one communication passing through the at least one first node, information meeting the criteria, and providing the captured information to at least a second one of the nodes of the network.

According to one example embodiment of the invention, the at least one first node includes one of an Optical Network Terminal (ONT), an Optical Line Terminal (OLT), a Remote Terminal (RT), and a Network Terminal (NT), and the at least one second node includes an Element Management System (EMS) (or an OLT). In a case where the first node is an ONT, NT, or RT, the information is provided from that node to the EMS by way of an OLT, in one example embodiment of the invention.

According to another example embodiment of the invention, the information includes traffic captured at a lower layer (e.g., Layer 2 or 3), such as Ethernet, ATM, or Frame Relay frames, or other lower-level information, and the method further comprises presenting the information in a decomposed, interpretable format. In one example embodiment of the invention, the decomposed format includes higher layer information (e.g., Layer 3 or 4, respectively) that was included in the captured information.

According to a further example embodiment of the invention, the criteria includes at least one of criteria for triggering the capturing of the information and criteria specifying content of information to be captured. The criteria specifies at least one event or condition for triggering capturing of the information, and the method can further comprise detecting the at least one triggering event or condition, wherein the capturing of the information is performed in response to the detecting of the triggering event or condition.

By virtue of the example method described above, lower-level information, such as, for example, Ethernet frames or the like, can be captured at a network element, such as an ONT, in response to a request from a remote communication node, such as an EMS or OLT. That information then can be provided to the remote communication node for use in, for example, diagnostics, trouble-shooting, and the like, and can be presented to a user.

According to one example embodiment of the invention, the method enables an ONT to communicate with (e.g., from an OLT and/or EMS) to program the collection and retrieval of information. This can be locally at the ONT or remotely from an OSS, for example. Also, as described above, collection of frame information, for example, can be scheduled or triggered under certain conditions or in response to the occurrence of certain events. As but one example, information specifying the schedule and/or triggering conditions (e.g., generation of a notification by an ONT) can be programmed into the EMS, or the collection can be performed autonomously (e.g., at boot up of an ONT), or scheduled periodically. Also, captured information can be retrieved from the element that performed the capturing, and can be displayed and analyzed either remotely or locally. The result of any such analysis (which, e.g., can be performed by an expert server or system) can be provided to a user or another network element.

### BRIEF DESCRIPTION OF THE DRAWINGS

FIG. 1 represents a conventional FTTx network.

FIG. 2 is a network diagram of an example FTTx network with an EMS in accordance with an example embodiment of the present invention.

FIG. 3 is a network diagram of an example FTTx network with an EMS in accordance with another example embodiment of the present invention.

FIG. 4 is a network diagram of an example communication network, which may be a more detailed version of the networks of FIGS. 2 and/or 3.

FIGS. 5-9 are flow diagrams that illustrate methods in accordance with example embodiments of this invention.

FIG. 10 is an architecture diagram of a processing system in accordance with an example embodiment of the present invention.

FIG. 11 is a logical diagram of a circuit device in accordance with an example embodiment of the present invention.

FIG. 12 is an example of a known display of information captured at local equipment.

### DETAILED DESCRIPTION OF THE INVENTION

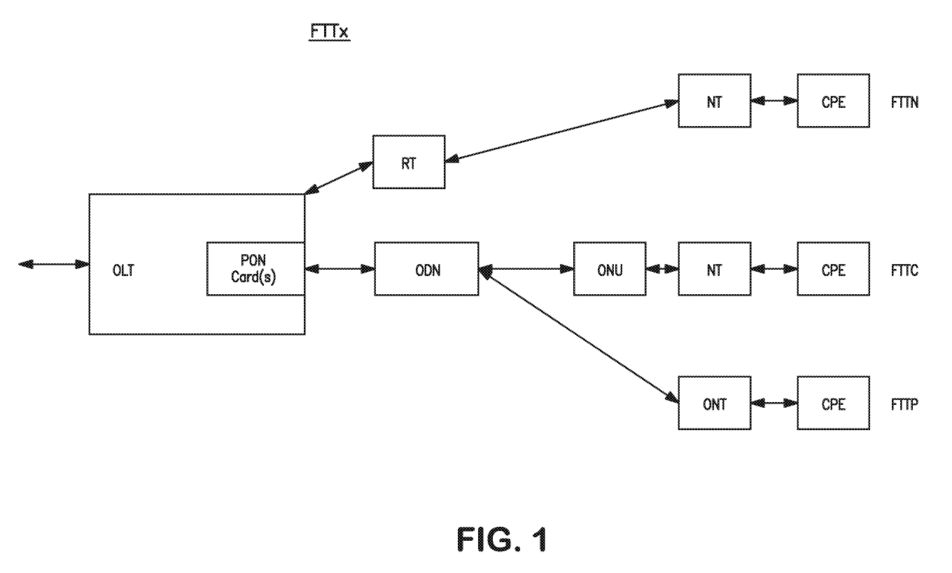

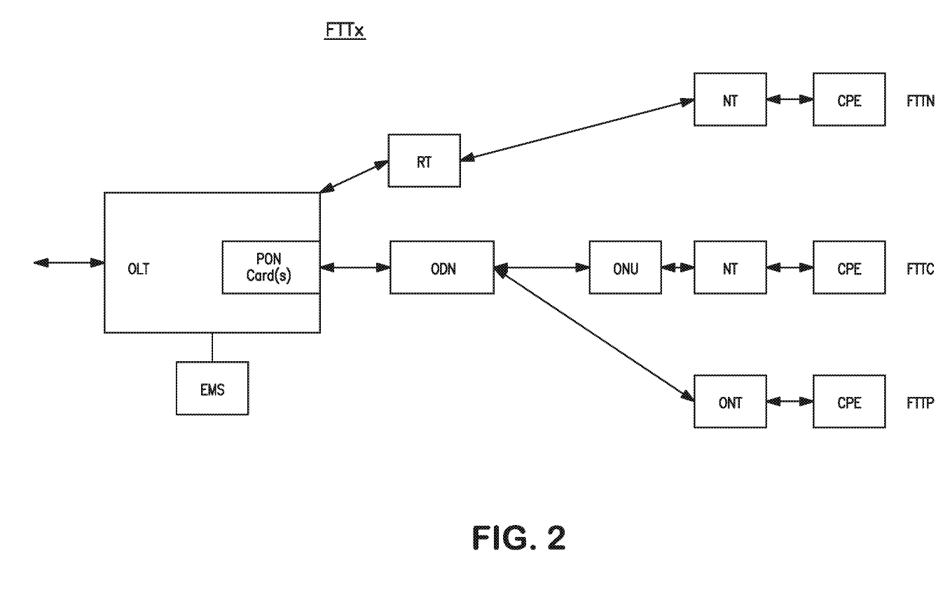

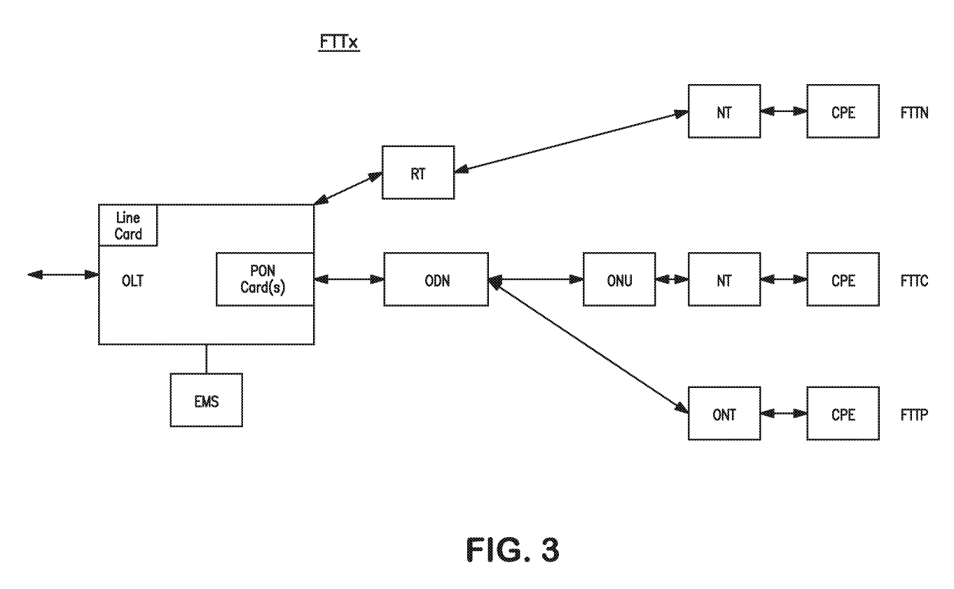

FIG. 2 is a network diagram of an example FTTx network with an Element Management System (EMS) in accordance with an example embodiment of the present invention, and FIG. 3 is a network diagram of an example FTTx network with an EMS in accordance with another example embodiment of the present invention. The networks of FIGS. 2 and 3 are similar to that of FIG. 1 described above, except that FIGS. 2 and 3 also depict an EMS that can be operated in accordance with an aspect of the present invention. An EMS may be deployed for FTTx network applications, and can include hardware and software that enables an operator to monitor, control, and generally manage the network through a suitable user-interface, such as a Graphical User Interface (GUI).

As will be understood in more detail in view of the below description, in the embodiment of FIG. 2 the EMS can control the ONT, ONU, RT, and NT, to cause each individual one to enter a “Frame Capture Mode” (to be described below), whereas in the embodiment of FIG. 3, both the EMS and OLT can independently control the ONT, ONU, RT, and NT to cause each individual one to enter the “Frame Capture Mode”. In the embodiment of FIG. 3, the OLT has this capability by virtue of one or more line cards installed therein, or otherwise associated therewith. In other embodiments of the invention, the ONT, ONU, RT, and NT can be pre-programmed to enter the “Frame Capture Mode” independently. As a non-limiting example, the ONT, ONU, RT, and NT can enter that mode in response to one or more triggering events or conditions such as, for example, predetermined times or intervals being reached, in response to command information being entered into a maintenance port thereof, etc., as will be further described below. In further embodiments of the invention, another network device and/or application in the network (e.g., independent of FTTX equipment) besides an EMS or OLT can control the ONT, ONU, RT, and NT to cause each individual one to enter the “Frame Capture Mode”.

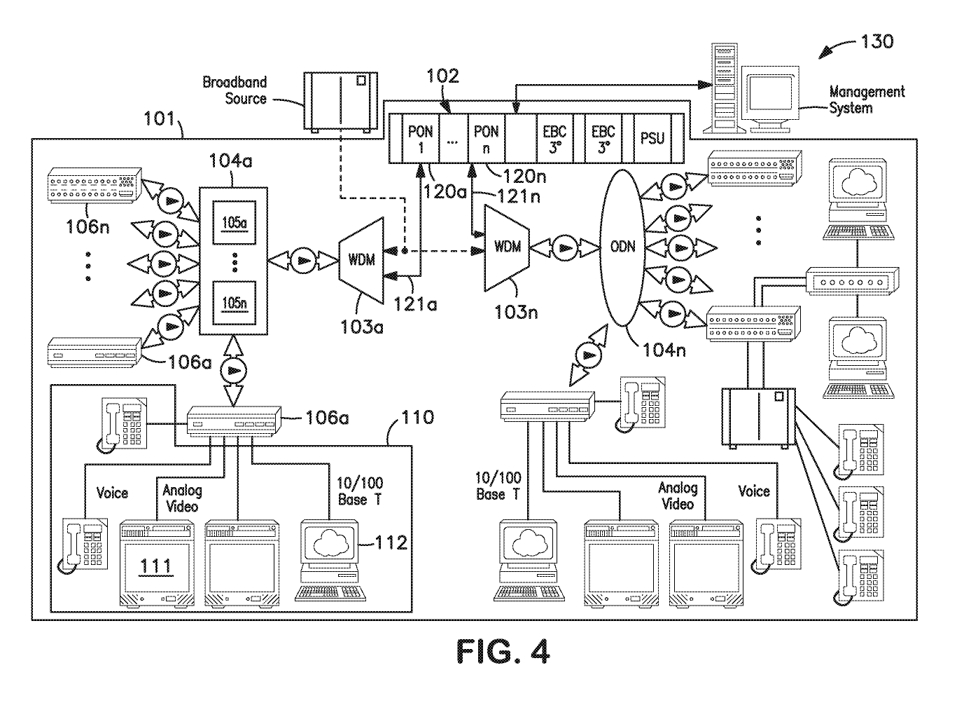

FIG. 4 is a network diagram of an example FTTP communication system or network, which may be a more detailed version of the networks of FIGS. 2 and/or 3, although it should be recognized that those networks can include FTTC and/or FTTN networks instead, or another type of network. For convenience, this description is described primarily in the context of a FTTP application. However, it should be understood by one skilled in the art in view of this description that the invention is not limited to FTTP applications only, and also can be used in other types of FTTx networks as well, including without limitation, FTTC and FTTN networks. For example, the functions performed by the ONTs and/or OLTs, as described below also can be performed by other network elements, such as NTs, RTs, and/or ONUs.

Referring now to FIG. 4, a Passive Optical Network (PON) 101 of the system includes an optical line terminal (OLT) 102, wavelength division multiplexers 103a-n, optical distribution network (ODN) devices 104a-n, ODN device splitters (e.g., 105a-n associated with ODN device 104a), optical network terminals (ONTs) (e.g., 106-n corresponding to ODN device splitters 105a-n), and customer premises equipment (e.g., 110). The OLT 102 includes PON cards 120a-n, each of which provides an optical feed (121a-n) to ODN devices 104a-n. Optical feed 121a, for example, is distributed through corresponding ODN device 104a by separate ODN device splitters 105a-n to respective ONTs 106a-n in order to provide communications to and from customer premises equipment 110.

The PON 101 may be deployed for fiber-to-the-business (FTTB), fiber-to-the-curb (FTTC), and fiber-to-the-home (FTTH) applications, for example. The optical feeds 121a-n in PON 101 may operate at bandwidths such as 155 Mb/sec, 622 Mb/sec, 1.25 Gb/sec, and 2.5 Gb/sec or any other desired bandwidth implementations. The PON 101 may incorporate, for example, ATM communications, broadband services such as Ethernet access and video distribution, Ethernet point-to-multipoint topologies, BPON communications, GPON communications, EPON communications, and native communications of data and time division multiplex (TDM) formats. Customer premises equipment (e.g., 110) which can receive and provide communications in the PON 101 may include standard telephones (e.g., Public Switched Telephone Network (PSTN)), Internet Protocol telephones, Ethernet units, video devices (e.g., 111), computer terminals (e.g., 112), digital subscriber line connections, cable modems, wireless access, as well as any other type of customer premise equipment.

PON 101 can include one or more different types of ONTs (e.g., 106a-n). Each ONT 106a-n, for example, communicates with an ODN device 104a through associated ODN device splitters 105a-n. Each ODN device 104a-n in turn communicates with an associated PON card 120a-n through respective wavelength division multiplexers 103a-n. Wavelength division multiplexers 103a-n are optional components which are used when video services are provided. Communications between the ODN devices 104a-n and the OLT 102 occur over a downstream wavelength and an upstream wavelength. The downstream communications from the OLT 102 to the ODN devices 104a-n may be provided at, for example, 622 megabytes per second, which is shared across all ONTs connected to the ODN devices 104a-n. The upstream communications from the ODN devices 104a-n to the PON cards 120a-n may be provided at, for example, 155 megabytes per second, which is shared among all ONTs connected to ODN devices 104a-n, although the invention is not limited to those specific types of downstream and upstream communications only, and may also include the types of example communications referred to above or any other suitable types of communications.

FIG. 4 further illustrates the OLT 102 managed by an element management system (EMS) 130. Since the OLT 102 includes the PON cards 120a-n, each PON card 120a-n is also managed by the EMS 130. As such, a single EMS manages all PON cards within a PON.

A single EMS, however, may manage or otherwise be associated with more than one PON. As such, a single EMS is not limited to managing PON cards within a single PON, by may manage PON cards from several PONs. In other embodiments, more than one EMS can be employed to manage PON cards within a single or plural PONs.

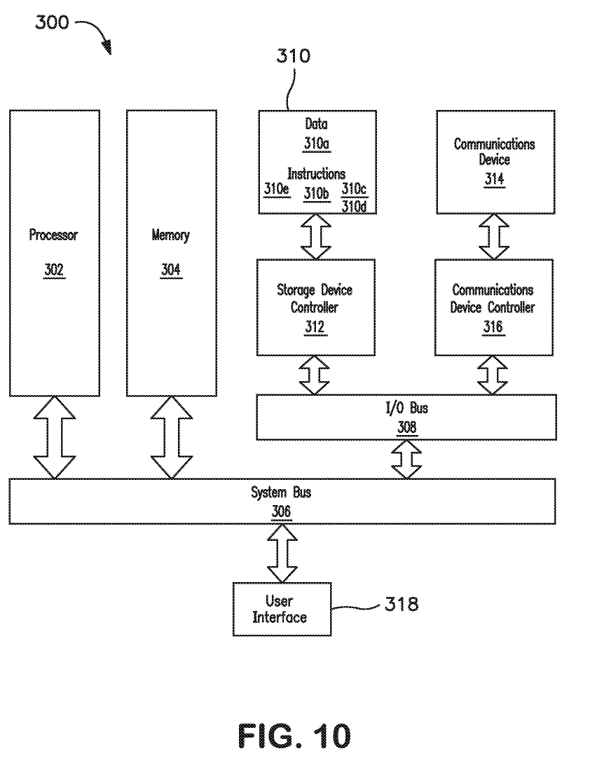

FIG. 10 is an architecture diagram for an example data processing system 300, which, according to an example embodiment, can form individual ones of the components 110, 130, 102, 104a-n, 106a-n (FIG. 4), and individual ones of the OLT, RT, ODN, ONU, EMS, NT, ONT, and CPE, of FIGS. 2 and 3. Data processing system 300 includes a processor 302 coupled to a memory 304 via system bus 306. Processor 302 is also coupled to external Input/Output (I/O) devices (not shown) via the system bus 306 and an I/O bus 308, and at least one input/output user interface 318. Processor 302 may be further coupled to a communications device 314 via a communications device controller 316 coupled to the I/O bus 308. Processor 302 uses the communications device 314 to communicate with a network, such as, for example, a network as shown in any of FIGS. 2-4, and the device 314 may have one or more input and output ports. Processor 302 also can include an internal clock (not shown) to keep track of time, periodic time intervals, and the like.

A storage device 310 having a computer-readable medium is coupled to the processor 302 via a storage device controller 312 and the I/O bus 308 and the system bus 306. The storage device 310 is used by the processor 302 and controller 312 to store and read/write data 310a, frame capture triggering criteria 310c (described below), frame capture content criteria 310d (described below), and network component identifier criteria 310e, as well as program instructions 310b used to implement the procedures described below. In operation, processor 302 loads the program instructions 310b from the storage device 310 into the memory 304. Processor 302 then executes the loaded program instructions 311b to perform any of the example methods described below, for operating the system 3 (which forms individual ones of the components 110, 130, 102, 104a-n, 106a-n, and individual ones of the OLT, RT, ODN, ONU, EMS, NT, ONT, and CPE of FIGS. 2 and 3). The processor 302 also has the capability to recognize when triggering conditions specified by the frame capture triggering criteria 310c have occurred, and to capture, store in device 310, retrieve, and forward frames meeting the frame capture content criteria 310d.

### Frame Capture Initiation at EMS

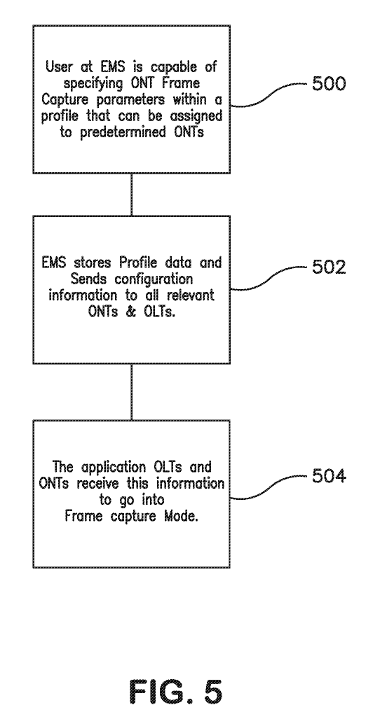

A method in accordance with an example aspect of the invention will now be described, with reference to FIGS. 4 and 5. In accordance with this aspect of the invention, a frame capture provisioning mode (also referred to as the “Frame Capture Mode”) is provided in which an operator of the EMS 130 can specify frame capture parameters within a profile. At block 500 the operator of the EMS 130 specifies the frame capture parameters by entering them through interface 318 of the EMS 130. The frame capture parameters specify frame capture triggering criteria 310c and frame capture content criteria 310d, and, according to one example embodiment of the invention, they also can include network component identifier criteria 310e that identifies which network component(s), such as, for example, one or more of the ONTs 106a-n and OLTs 102, should capture frames based on the criteria 310c and 310d. In other embodiments, the EMS 130 can be pre-programmed with default criteria 310c, 310d, and 310e and thus no such criteria needs to be specified in block 500.

The frame capture content criteria 310d specifies content criteria or rules for capturing information, such as frames. As non-limiting examples, the criteria 310d may specify one or more of the following: that the frames to be captured include downstream frames, upstream frames, or both, that a predetermined number of consecutive frames or every Nth frame should be captured (possibly in response to one or more triggering events or conditions, or over one or more predetermined time intervals or at predetermined times), that only frames with specific attributes/characteristics be captured, and/or that only frames from one or more specific types of services, such as, for example, data services and/or IP TV Video services, or the like, be captured.

The frame capture triggering criteria 310c specifies one or more predetermined triggering events or conditions which, upon being detected by an applicable network component, should initiate frame capturing. For example, the criteria 310c may specify that frame capturing begin upon one or more of the following events or conditions being detected: the component (e.g., ONT 106a-n) first booting up and/or detecting activity on an interface thereof (e.g., an Ethernet interface of device 314) for a first time, or at any other times, upon Ethernet Port Admin state Toggling, upon detection of a loss of signal or one or more alarms/notifications (e.g., Multiple LAN-LOS (LAN Loss of Signal) or other types of notifications) within a predetermined time period or at each individual or plural detections, upon detection of an ARP request (in which case capturing includes at least recording a DHCP address communication), upon detection of a predetermined amount of errors (e.g., Ethernet Errors) within a predetermined time period or at each individual detection or plural detections, upon learning a predetermined number of Number Source Addresses within a predetermined amount of time, upon detecting predetermined invalid information within received frames, IP Packets, or other types of information, upon the component detecting invalid VLAN information in incoming traffic, in response to command information being entered into a maintenance port (i.e., a maintenance port of device 314 of FIG. 10) or user interface 318 of the component, in response to an interface of the component such as, for example, a LAN interface becoming disabled and/or re-enabled, or based on any other predetermined triggering criteria.

Of course, the various examples given above are not exhaustive, and it is within the scope of this invention for the criteria 310c and 310d to specify other types of triggering and content criteria as well, and for the criteria to specify that frame capturing be performed in response to the occurrence of more than one predetermined triggering event or condition, and/or that a predetermined number of consecutive or non-consecutive frames be captured in response to one or more predetermined triggering events or conditions. As but one example, the criteria 310c and 310d may specify that a predetermined number of frames be captured upon the expiration of a predetermined time period beginning upon the occurrence of another event or condition, such as, for example, an initial booting or re-booting of a network component, such as an ONT 106a-n.

The particular types of criteria 310c and 310d that are employed can depend on the application of interest. As but one example, in a case where it is desired to detect whether a rogue user is attempting to hack into particular customer premise equipment 110, the criteria 310c and 310d may specify the capture of the next 100 received Ethernet frames upon the equipment learning 50 different MAC Addresses within 10 seconds. As another example, in cases where the storage device 310 of an ONT 106a-n is limited in size, the criteria 310c and 310d may specify that frames be collected periodically (e.g., every 15 minutes) to ensure continuous diagnostic capabilities, and/or that the first N frames be captured over a predetermined time period until a buffer for that period is full, or after an ONT ranges or re-ranges, or a LAN-LOS/MOCA LOL alarm clears.

Referring again to FIG. 5 (and FIG. 4), at block 502 the EMS 130 stores the criteria 310c, 310d, and/or 310e specified in block 500 in its storage device 310, and sends the criteria to any network components (also referred to herein as “network elements”), such as, for example, one or more of the ONTs 106a-n and/or OLTs 102, identified by the criteria 310e.

At each such receiving network component, upon receiving the criteria from the EMS 130, the component responds by storing the received criteria in its own storage device 310, and monitors for the occurrence of triggering event(s) or condition(s) specified by the frame capture triggering criteria 310c (block 504), as will be described in more detail below. As also will be described in more detail below, when a component, such as, for example, an ONT 106a-n, detects the event(s) or condition(s) specified by the criteria 310c, it enters the “Frame Capture Mode” (also referred to as a “diagnostic mode”), wherein it captures frames based on the frame capture content criteria 310d, although in other embodiments the component can enter that mode immediately in response to receiving the criteria or upon a command being received from an external source, such as EMS 130 or OLT 102, or through a user interface 318 of the component.

In another example embodiment of the invention, a network component, such as, for example, an ONT 106a-n, can enter the “Frame Capture Mode” on its own at block 504, without being triggered by an external source such as the EMS 130, to capture frames in a manner specified by criteria 310c and 310d stored therein. Also, the criteria 310c and 310d can be pre-stored in any such element(s), and does not need to be provided from another network element, such as EMS 130.

### Frame Capture Mode

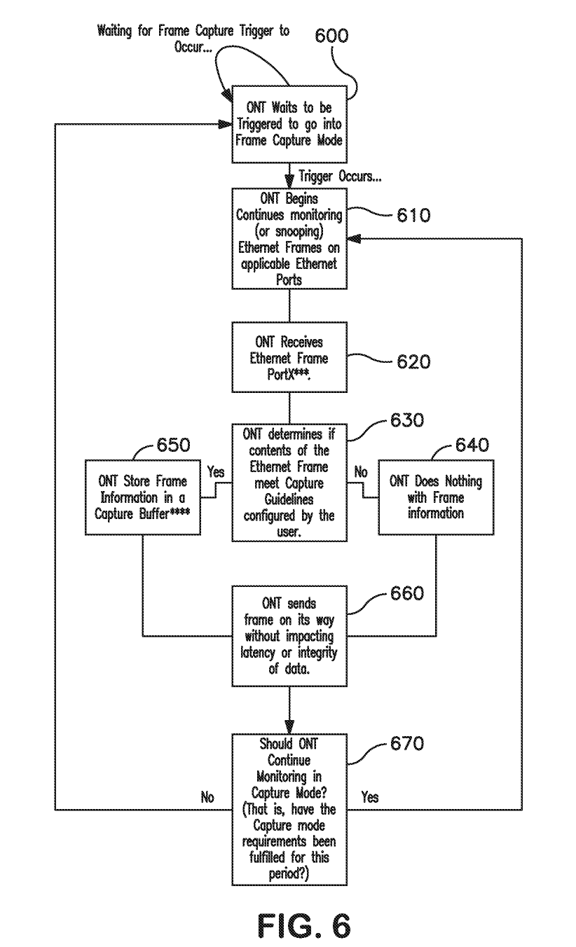

FIG. 6 will now be described. FIG. 6 is a flow diagram representing a procedure by which the “Frame Capture Mode” is implemented in a network component, such as an ONT 106a-n (or an OLT 102, RT, ODN, ONU, or NT). At block 600, the ONT 106a-n waits to be triggered to enter into the “Frame Capture Mode”. For example, depending on the frame capture criteria 310c provided in the ONT 106a-n, the ONT may monitor for one or more of the following events or conditions as described above: a first booting up of the component and/or detection of activity on an interface thereof (e.g., an Ethernet interface of device 314) for a first time, or at any other times, Ethernet Port Admin state Toggling, detection of a loss of signal or one or more notifications (e.g., Multiple LAN-LOS (LAN Loss of Signal) or other types of notifications) within a predetermined time period or at each individual detection or plural detections, detection of an ARP request, detection of a predetermined amount of errors (e.g., Ethernet Errors) within a predetermined time period or at each individual detection or plural detections, learning of one or more Number Source Addresses within a predetermined amount of time, detection of predetermined invalid information within received frames, IP Packets, or other types of information, detection of invalid VLAN information in incoming traffic, command information being entered into a maintenance port (i.e., a maintenance port of device 314 of FIG. 10) or user interface 318 of the component, an interface (of device 314) such as, for example, a LAN interface of the component becoming disabled and/or re-enabled (as recognized by the processor 302), or based on any other predetermined triggering criteria.

In response to the ONT 106a-n detecting a triggering event or condition at block 600, the ONT 106a-n begins monitoring (by, for example, “snooping”) for information, such as frames, meeting the frame capture content criteria 310c. In an example embodiment, the ONT 106a-n monitors for Layer 2 (or 3) information, such as Ethernet frames, on applicable Ethernet ports (e.g., of device 314, associated with the communication path(s) of interest) (block 610).

After block 610, the flow continues at block 620 in which the ONT 106a-n receives a frame (e.g., an Ethernet frame) through communications device 314 (on, for example, a Port X or a data port of device 314). Such a frame is, for example, either a downstream frame received from the OLT 102 and destined to be output by the ONT (via, e.g., a data port) to customer premises equipment 110, or an upstream frame received at a specific ONT port and destined to be output to the associated OLT 102.

At block 630, the ONT 106a-n determines whether the frame received at block 620 meets the frame capture content criteria 310d (e.g., such as the criteria 310d specified at block 500 of FIG. 5). As an example, this step may include one or more of the following: determining whether the frame is a downstream frame or an upstream frame, depending on which type is specified by criteria 310d, determining whether the frame includes predetermined attributes/characteristics specified by criteria 310d, determining whether the frame is from one or more specific types of services, such as, for example, data services, telephony services, and/or IP TV Video services specified by criteria 310d, or the like, and/or determining that the frame is associated with a particular data file, packetized voice stream (which, e.g., the ONT detects by looking up layers in the stream, or the like), although in other embodiments block 630 may include other types of determinations as well, depending on the criteria 310d. The manner in which the ONT 106a-n makes these determinations can be in accordance with any suitable respective techniques.

If the frame does not meet the criteria 310d (“No” at block 630), the ONT 106a-n does nothing with the frame at block 640, and control passes to block 660. If, on the other hand, the frame meets the criteria 310d (“Yes” at block 630), the ONT 106a-n stores a copy of the frame in a capture buffer (of storage device 310) at block 650, and control then passes to block 660. The capture buffer may include, for example, a volatile (RAM) memory or can be a non-volatile memory, and the specific type of memory employed can depend on the criteria 310d. Storage in a non-volatile memory can provide another mechanism to analyze the captured information if the ONT 106a-n is removed from service.

After blocks 640 and 650, the frame is sent from the ONT 106a-n towards its destination without, for example, impacting latency or integrity of the data flow (block 660). According to another example embodiment of the invention, block 660 is a decision block that includes determining whether the frame should be dropped or sent towards its destination. That determination can be made based on predetermined criteria, such as, for example, based on a result of block 630.

At block 670, a decision is made as to whether the ONT 106a-n should continue monitoring in the frame capture mode, based on, for example, whether applicable frame capture triggering criteria 310c have been fulfilled. For example, this decision may include one or more of determining whether a predetermined number of consecutive or non-consecutive frames has now been received, determining whether that number of consecutive or non-consecutive frames has been received over one or more predetermined time intervals or by predetermined times, and determining whether a predetermined time interval has been reached and the like, depending on the criteria 310c. If the determination result is “yes”, the flow returns to block 610 to continue monitoring and to perform the subsequent procedures thereafter. If, however, the determination result is “no”, the flow continues to block 600 to wait for the next triggering event in the above-described manner.

In another example embodiment of the invention, a network component, such as an ONT 106a-n, can capture frames using a “rolling window” procedure, in which the component captures a predetermined number of the most recently received frames (e.g., the last 100 frames) that pass through it, as defined by the criteria 310d stored in the component's storage device 310. In an example embodiment, one or more network components (e.g., ONTs 106a-n) perform this procedure using a FIFO device, wherein the most recently received frame is captured and stored, and an earliest frame stored in the FIFO device is removed, although in other embodiments the procedure can be performed using other suitable techniques.

The “rolling window” procedure can be useful in cases in which, for example, there is an insufficient amount of memory storage available to store large amounts of data, or where it is desired to avoid losing evidence of certain conditions (e.g., hacking etc.) that may be occurring. For example, while it can be useful to trigger the capturing of frames upon an ONT learning fifty different Ethernet source MAC addresses, if the ONT has not captured the last fifty Ethernet frames that contained the different MAC addresses, then this information can be undesirably lost. By capturing those frames using the “rolling window” procedure, however, this limitation can be avoided. In such a manner, the ONT can continuously track (and store) a “rolling window” of frames to maintain evidence of past events.

The “rolling window” procedure also can be used in conjunction with other frame capture criteria. As an example, in some example embodiments of the invention, while an ONT 106a-n is operating according to the “rolling window” procedure, the ONT also captures frames in a manner as specified by the criteria 310c and 310d and described above with respect to FIG. 6. For example, the ONT 106a-n can be triggered to capture frames according to any of the example criteria 311c and 310d described above, while simultaneously operating using the “rolling window” procedure, and the number of captured frames in each operation may be the same or different from each other. In a case in which the “rolling window” procedure captures the most recently received 100 frames, for example, it may be desirable to operate the ONT so that it captures the next 1000 frames in response to a triggering event. Based on criteria 310c and 310d along those lines, the ONT can capture the 100 frames that lead to the triggering event, as well as the next 1000 frames that are received after the triggering event occurred.

According to another example embodiment, frame capturing can be performed so that there are multiple frame capture stages or levels that capture frames based on respective criteria. For example, lower level information (e.g., Layer 2 or 3) meeting predetermined frame capture criteria 310c and/or 310d can be captured at a lower level frame capture stage, and higher level (e.g., Layer 3 or 4, respectively) information meeting other criteria (e.g., frames associated with one or more particular files, packetized voice streams, video, etc.) 310c and/or 310d can be captured at a higher level frame capture stage. Each stage can be operational simultaneously, and the “rolling window” procedure also can be used simultaneously as well.

### Frame Capture Manual Request

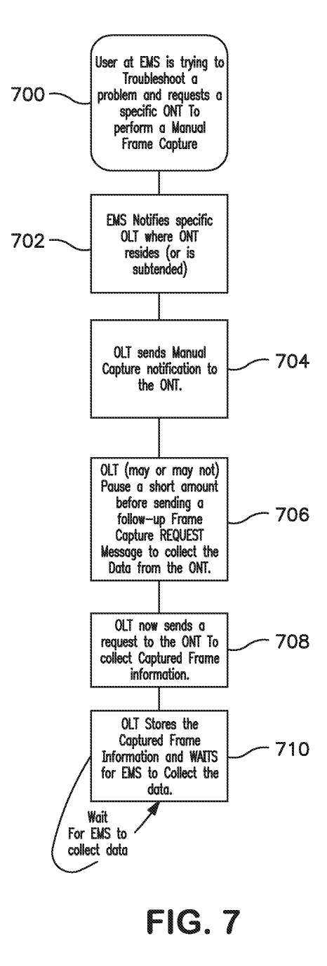

In accordance with another example aspect of the invention, a frame capture manual request procedure can be performed in which one or more OLTs 102 can be tasked with requesting one or more ONTs 106a-n (or RTs, NTs, ONUs, ODNs) with capturing frames, as will now be described in conjunction with FIG. 7. The procedure of FIG. 7 can be initiated by, for example, an EMS operator who desires to troubleshoot a recognized system problem or malfunction relating to one or more ONTs 106a-n, and who thus enters a command into the EMS 130 requesting the ONT(s) 106a-n to perform a manual frame capture (block 700). For example, the request can select default criteria 310c, 310d, and/or 310e, or such criteria can be specified by the operator at the EMS 130, as in block 500 described above. In other examples, the frame capture request can be entered into another network element, such as an OLT 102, which provides the request to the element to perform the capturing, such as an OLT 106a-n, or, in other examples, the request can be inputted directly into the ONT(s). However, it should be noted that, for convenience, the below description is described in the context of the request being inputted into the EMS 130.

After block 700, the EMS 130 responds by notifying one or more specific OLTs 102 associated with the selected ONTs 106a-n (block 702) (as can be determined by, for example, the EMS 130 based on predetermined architecture information or based on criteria 310e), and provides the criteria 310c, 310d, and/or 310e obtained at block 700 to those OLT(s) 102. The OLT(s) 102 then respond by sending a manual capture notification, which can include the criteria 310c, 310d, and/or 310e, to the ONT(s) (block 704) to cause the ONT(s) to enter into the “Frame Capture Mode” in the above-described manner (see, e.g., block 600 of FIG. 6). Thereafter, in accordance with one embodiment of the invention, the OLT(s) 102 pause for a predetermined time interval in order to provide the ONT(s) with sufficient time to collect, process, and store the requested information (e.g., frames) (block 706), although in another embodiment no such pause is needed or made.

At block 708 the OLT(s) 102 send to the ONT(s) 106a-n a request for the ONT(s) to forward captured information (e.g., frames) (in which case the ONT(s) provide the requested information to the ONT(s) 102). Thereafter, at block 710 the OLT(s) 102 store the captured frame information obtained from the ONT(s) and wait for the EMS 130 to request collection of that information. The EMS 130 can collect that information, for example, upon an operator request being entered into the EMS 130, at period time intervals, or at any other suitable time or manner, and does so by communicating with the OLT(s) 102 to retrieve the information. In other example embodiments, the OLT(s) 102 provide the captured frame information to the EMS 130 automatically, without first being prompted by the EMS 130.

It should be noted that the forgoing procedure can be performed in addition to, or in lieu of, any periodic or otherwise automatic frame capturing technique described herein, even in cases where such periodic/automatic capturing techniques are already in process. For example, in a case in which an ONT is performing periodic frame capturing, an operator of the EMS 130 can initiate the above procedure in block 700 to cause on-demand capture of frames, even though the periodic frame capturing may already be in process and continuing to be performed.

### Frame Capture Auto-Mode at an OLT

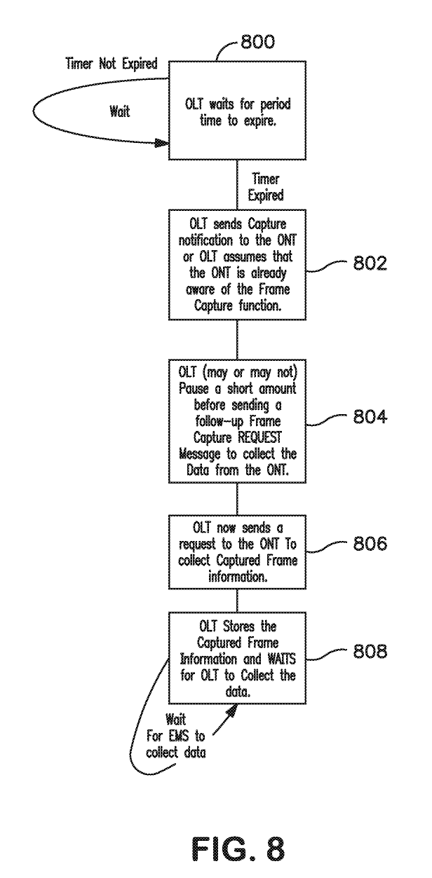

In accordance with another example aspect of the invention, a frame capture auto-mode procedure can be performed by a network component, such as, for example, an OLT (or OLTs) 102, as will now be described in conjunction with FIG. 8. An operator of the EMS 130 can pre-program criteria 310c, 310d, and/or 310e similarly as described above in connection with block 500 of FIG. 5, but in this case the criteria specified by the operator relates to the auto-mode procedure. That criteria is communicated to OLT(s) associated with the criteria 310e, and stored in those OLT(s). In another example embodiment, the criteria 310c, 310d, and/or 310e is provided to the OLT(s) from one or more other predetermined network elements and/or applications besides the EMS 130, and thus the invention is not limited to employing the EMS only to control the OLT(s). In still another example embodiment of the invention, the criteria 310c, 310d, and/or 310e programmed directly into the storage device 310 of the OLT 102, without intervention of the EMS 130. In this case, one or more line cards (test cards) are employed in the OLT 102, as represented in FIG. 3, wherein by virtue of the line card(s), the OLT 102 can place the ONT in the diagnostic mode without intervention of the EMS 130. According to an example embodiment of the invention, the line card has a capability to snoop and capture real-time traffic (e.g., Layer 2 and 3 traffic) from an OLT or ONT, with more granularity than was previously possible, in at least some cases. Line cards also can provide additional processing capability that some OLTs or ONTs cannot perform to conduct the functionality described herein. Line cards also can provide the capability of storing a greater amount of information, and stored information can be more secure within a line card than within an OLT without such a card. This line card feature can be useful in cases where OLT or ONT products do not support all functions, but only some described herein. In such a situation, it can be convenient to simply add an extra line card that provides the additional functionality rather than replace or change the complete device, such as an OLT or ONT. Of course, a corresponding embodiment of the network of FIG. 4 also can incorporate such line cards in OLTs 102 or ONTs 106a-n.

At block 800, an OLT 102 provided with the above criteria monitors for the occurrence of one or more triggering events or conditions, such as, for example, a predetermined date and/or time being reached, a predetermined communication being received from the EMS 130, or the like, as described above, and depending on which triggering events and/or conditions are specified by the criteria 310c.

Upon a triggering event defined by the criteria 310c being detected (e.g., the expiration of a predetermined amount of time or the like), control passes to block 802 where the OLT 102 sends a capture notification, which can include the criteria 310c, 310d, and/or 310e, to one or more associated ONTs 106a-n to cause the ONT(s) to operate in the “Frame Capture Mode” in the manner described above, or, in another embodiment, the OLT 102 assumes that the ONT(s) already are aware of (and operate in) the “Frame Capture Mode” and does not notify the ONT(s). Thereafter, in accordance with one embodiment of the invention, the OLT 102 pauses for a predetermined time interval in order to provide the ONT(s) 106a-n with sufficient time to collect, process, and store applicable requested frame information (block 804), although in another embodiment no such pause is needed or made.

Control then passes to block 806 where the OLT 102 sends to the ONT 106a-n a request for the ONT(s) to forward captured frame information (meeting the criteria 310c and 310d), in which case the ONT(s) provide the captured frame information to the OLT 102. Frame information provided by ONT(s) to an OLT and/or EMS can, in one example embodiment be communicated via a secure OMCI channel, although in other embodiments the information can be provided via other channels and/or over the Internet or the like.

Next, at block 808 the OLT 102 stores captured frame information received from the ONT(s) 106a-n, and then waits for the EMS 130 to request collection of that information. The EMS 130 can collect that information upon an operator request being entered therein, at period time intervals, or in any other suitable manner, and communicates with the ONT(s) to retrieve the information in accordance therewith.

### Retrieval and Presentation of Captured Frame Information

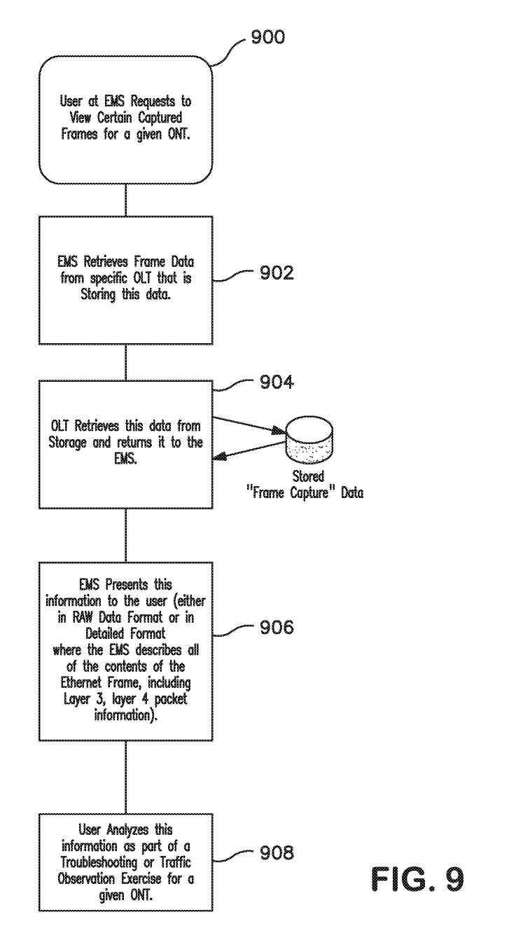

FIG. 9 will now be described. FIG. 9 is a flow diagram representing a procedure by which the frame capture mode can be requested at a network component, such as EMS 130 or another diagnostic server or other network element and/or application, and frame information and content can be presented to the operator at that component. At block 900 the operator of the component, such as EMS 130, enters information therein requesting to view certain one or more frames captured by a selected one or more of the ONTs 106a-n. For example, the frames may have been captured periodically, manually (e.g., in response to an operator-entered command), or the like depending on the criteria 310c and 310d described above, and the entered information may define which frames are requested based on one or more of such criteria. Also by example, block 900 may be performed in the same manner as block 500 of FIG. 5 described above, to initiate frame capturing.

In response to block 900, EMS 130 initiates retrieval of frame information from the specific OLT(s) which retrieved the information from the ONT(s) 106a-n (block 902) (e.g., in one embodiment this procedure may be performed in the same manner as blocks 502, 708, 710, and 808 described above), although in other embodiments the EMS 130 (or other network element and/or application) communicates directly with the ONT(s) to initiate (and retrieve) frame information. As a result, the OLT(s) (or ONT(s)) retrieve the requested frame information from their associated storage device 310 (or the OLT(s) retrieve it from the ONT(s) 106a-n, if the information has not been obtained by the OLT(s) already), and forward the information to the EMS 130 (block 904). Next, at block 906, the EMS 130 presents the retrieved information to the operator, either in raw data form, at the same Layer as that in which the information was captured, or in detailed format (such as, e.g., EtherReal display format or another predetermined format) which reveals the frame content (e.g., Ethernet frame contents), including, for example, higher layer information such as Layer 3 and/or Layer 4 packet information. For example, this information can be presented on or in a display, a printout, a packetized voice stream, video, or through any suitable type of user-perceptible output user-interface forming at least part of the interface 318 of EMS 130. The operator then can perceive this information, and interpret and analyze it as deemed necessary to conduct appropriate troubleshooting, one or more traffic observation exercises for a given ONT, and the like (block 908).

The EMS 130 can display or otherwise present the content of captured frames without the need to store this information in a flash memory or in an EMS 130 server, in an example embodiment of the invention, but it could do so in other embodiments. Also, in some embodiments the EMS 130 can support a display format that provides the ability to expand captured packet information of any layer (e.g., Layer 4 or other layer information) captured in a manner similar to that described above, and to analyze the specific fields within the captured packets. This feature provides additional troubleshooting features to the operator. By virtue thereof, the operator at the EMS 130 is able to analyze the specific content of packets that are directed to and from subscribers. Furthermore, this feature provides the operator with the ability to determine whether the data that is being received and transmitted from an ONT itself is valid.

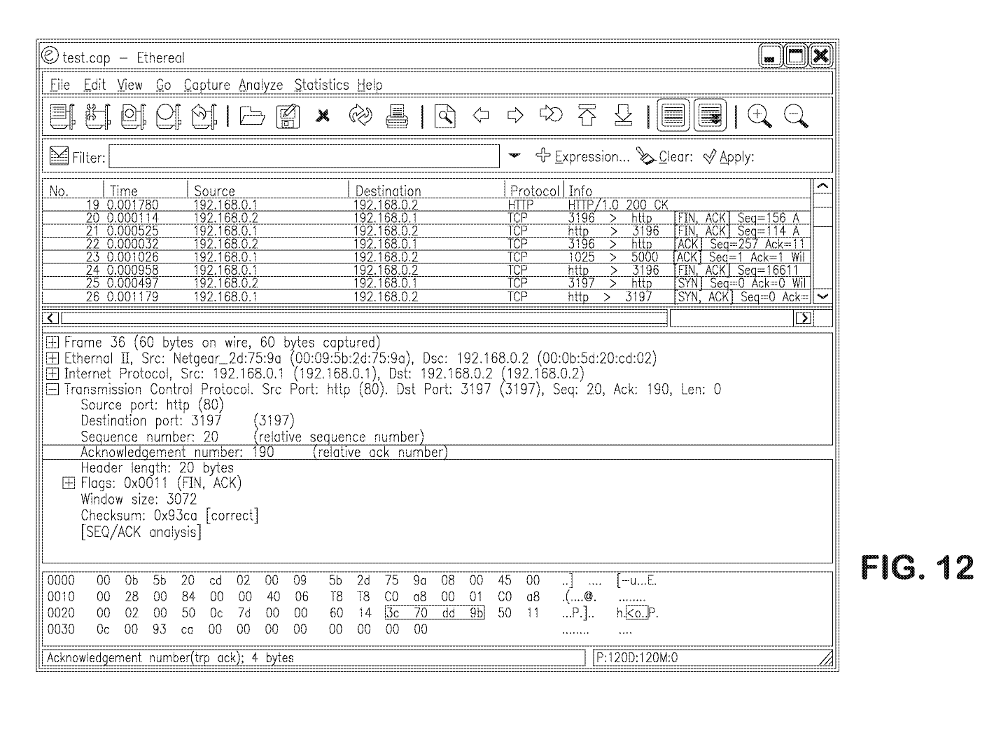

In one example embodiment of the invention, block 906 includes decomposing the captured information such that higher level information included therein is obtained and presented to the user. For example, in a case in which the captured information includes Layer 2 or 3 payloads, that information is decomposed so that Layer 3 or 4, respectively, datagrams carried by the Layer 2 or 3 payloads are obtained, and the obtained Layer 3 or 4 information is presented to the user. The decomposition can be performed using any known or future developed technique(s), such as, for example, using EtherReal software, and, in one example embodiment, can provide the resulting information in a format that is interpretable by a user and/or diagnostic analysis software or the like. An example of information that may be presented at block 906 is shown in FIG. 12.

According to another example aspect of the invention, information obtained at block 904 and/or 906 can be automatically analyzed by the EMS 130 or another diagnostic server of other network element, for diagnostic purposes. That analyzing device also can generate notifications and the like and forward the notifications to the user and/or to one or more predetermined network elements, such as OLTs, ONTs, or the like, if it is determined based on the analysis that predetermined conditions are present in the network. As but one example, in a case where an ONT 106a-n captures frames in the above-described manner (e.g., in response to detecting an ARP request or otherwise), the ONT in one example embodiment can analyze the captured information (whether in decomposed format or not) and generate a notification if one or more predetermined conditions are recognized from the analysis, such as, for example, an address not being returned to a BHR from a DHCP server, or another condition. The manner in which the analysis is performed and the diagnostic operations that may be performed as a result can be in accordance with any suitable known or later developed technique(s). In one example embodiment, those operations can be performed in accordance with the techniques described in U.S. application Ser. No. 11/784,427, entitled “METHOD AND APPARATUS FOR ANALYZING A NETWORK OR A NETWORK ELEMENT FAULT”, which is incorporated by reference herein in its entirety, as if fully set forth herein.

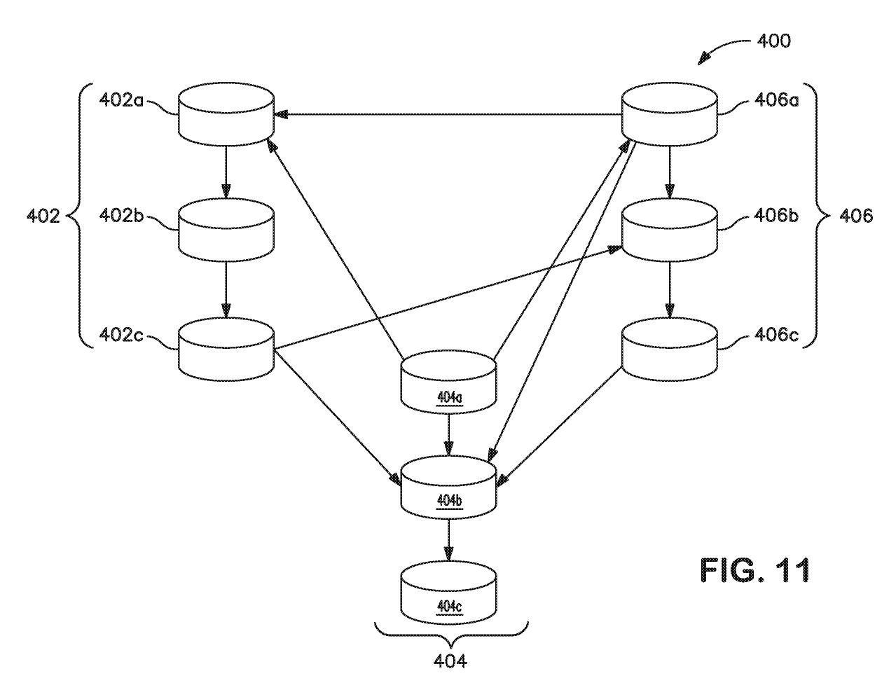

FIG. 11 illustrates a logical diagram 400 of the modules of an example communication system or similarly organized circuit device(s) (e.g., ASIC, PGA, FPGA, and the like) which could be used as components 102, 130, and/or 106a-n in accordance with example embodiments of the present invention. The modules may include hardware circuitry, software, and/or combinations thereof. In an example embodiment, software routines for performing the modules depicted in logical diagram 400 can be stored as instructions 310b in a storage device 310 and executed by processor 302 of one or more data processing systems 300 (FIG. 10). Logical diagram 400 includes an information capture module 402 which can perform procedures as shown in FIG. 6 described above, an information capture manager 404 which can perform the above-described procedures performed by the EMS 130, such as, for example, those represented by blocks 500, 502, 700, 702, 710, and 900-908, and an intermediate information capture manager 406 which can perform the above-described procedures performed by an OLT 102, such as, for example, those represented by blocks 700-710, 800-808, 902, and 904.

The module 402 includes a sub-module 402a which provides and/or stores criteria 310c, 310d, and/or 310e for capturing information such as frames in a network component, such as an ONT 106a-n, a sub-module 402b arranged to capture information meeting the criteria, and a sub-module 402c arranged to provide the captured information to at least one other network element, such as an OLT 102 and/or an EMS 130.

The manager 406 includes a sub-module 406a that can provide the criteria 310c, 310d, and/or 310d to sub-module 402a, a sub-module 406b that can retrieve captured information from sub-module 402c, and provide the information to sub-module 406c, and the sub-module 406c which can provide the captured information to a sub-module 404b of manager 404.

The manager 404 includes a sub-module 404a that can provide the criteria 310c, 310d, and/or 310d to sub-module 402a and/or sub-module 406a, a sub-module 404b that can retrieve captured information from sub-module 402c and/or sub-module 406a, and a presenter module 404c arranged to present retrieved captured information, to an operator, for example, in a higher-level format.

As described above, example embodiments of the invention enable an ONT to provide a snapshot of frames (e.g., Ethernet frames) to the EMS 130 for diagnostic purposes, by implementing methods such as those illustrated in FIGS. 5-9. As can be appreciated in view of the foregoing description, the ONTs support the ability to be configured in a mode for capturing and storing Ethernet frames or other types frames (such as a predetermined number of such frames or frames meeting some other specified criteria) and enabling the EMS 130 to retrieve these frames on demand, automatically, or otherwise. The EMS 130 enables the operator to operate the EMS 130 to remotely control the ONT to cause it to enter a diagnostic mode to capture frames in a specified manner (e.g., the next X# of frames within the next Y seconds or the like). The EMS 130 retrieves the captured frames and enables the operator to analyze the information.

As also can be understood in view of the above description, the timing for an ONT to capture Ethernet frames (Layer 2, 3 or similar) for diagnostic purposes can be controlled, in an example scenario, to capture the upstream frames, downstream frames, or both, depending on criteria 310d. In one example embodiment of the invention, captured upstream and/or downstream frames can be stored with a timestamp to identify specifically when they were received, captured and/or sent. For example, the applicable network component (e.g., ONT 106a-n) can determine the times when any such frames are received based on time kept by the internal clock of processor 302, and can then store captured frames in the storage device 310 along with time stamps representing the times. In other example embodiments of the invention, other types of information also can be stored along with the frames for providing additional troubleshooting information, depending on applicable operating criteria.

At least some aspects of the invention can be non-service affecting. For example, the above-described frame capturing procedure can be a “snooping” utility or deep packet inspection that is capable of enabling the viewing of particular information but which does not impact characteristics or integrity, including latency, of the data flows. If there are recognized risks of impacting services, it is within the scope of this invention to notify the operator that the capture mode is enabled and services may be impacted.

In accordance with another example embodiment of the invention, frames can be stored, in specific situations, in non-volatile memory prior to an ONT 106a-n being shut down, based on a direct command from an OLT 102 or, e.g., a “dying gasp” scenario, a loss-of-signal condition, or an emergency-stop condition. By virtue of the feature of storing frames in non-volatile memory, the operator has more information to diagnose problems when the ONT 106a-n is, for example, removed from service.

Although the above description has been described in the context of capturing Ethernet frames, it is within the scope of the present invention to capture other types of information as well, such as, without limitation, ATM Adaptation Layer (AALx) Package Data Unit (PDU) packages, Frame Relay frames, or the like. Thus, a quantum of information besides a frame, such as a packet or the like, also can be captured based on predetermined criteria 310c and 310d, in lieu of or in addition to frames, and thus the invention is not limited to capturing frames or Layer 2 or 3 information only. It also is within the scope of the invention for the EMS 130, OLT(s) 102, and/or ONTs 106a-n to have a capability of reporting problems with packets or frames to an operator by means of notifications and the like. Also, although the invention has been described in the context of the procedures of FIGS. 5-9 being performed by specific respective network components 130, 102, or 106a-n, in other embodiments of the invention those procedures can be performed by other ones of those components, any ONX devices (i.e., ONTs, ONUs, and line cards), or by other network components such as, for example, a network router, switch, a RT, NT, ONU, or ODN, or other network node device. In other example embodiments of the invention, collection of captured information can be performed by a computer (in lieu of an OLT) that communicates periodically with the ONT to obtain the information. In either case, such a communication can be Inband (using the OLT), or an out of band request directly to the ONT. Furthermore, in another example embodiment of the invention, retrieval of captured information from an ONT or the like can include retrieving historical logs of the captured information for storage on a remote server or other network element described herein, for subsequent analysis.

In the foregoing description, example aspects of the invention are described with reference to specific example embodiments thereof. The specification and drawings are accordingly to be regarded in an illustrative rather than in a restrictive sense. It will, however, be evident that various modifications and changes may be made thereto, in a computer program product or software, hardware, or any combination thereof, without departing from the broader spirit and scope of the present invention.

Software embodiments of example aspects of the present invention may be provided as a computer program product, or software, that may include an article of manufacture on a machine accessible or machine readable medium (memory) having instructions. The instructions on the machine accessible or machine readable medium may be used to program a computer system or other electronic device. The machine-readable medium may include, but is not limited to, floppy diskettes, optical disks, CD-ROMs, and magneto-optical disks or other types of media/machine-readable medium suitable for storing or transmitting electronic instructions. The techniques described herein are not limited to any particular software configuration. They may find applicability in any computing or processing environment. The terms “machine accessible medium” or “machine readable medium” used herein shall include any medium that is capable of storing, encoding, or transmitting a sequence of instructions for execution by the machine and that cause the machine to perform any one of the methods described herein. Furthermore, it is common in the art to speak of software, in one form or another (e.g., program, procedure, process, application, module, unit, logic, and so on) as taking an action or causing a result. Such expressions are merely a shorthand way of stating that the execution of the software by a processing system causes the processor to perform an action to produce a result. In other embodiments, functions performed by software can instead be performed by hardcoded modules, and thus the invention is not limited only for use with stored software programs.

In addition, it should be understood that the figures illustrated in the attachments, which highlight the functionality and advantages of the present invention, are presented for example purposes only. The architecture of example aspect of the present invention is sufficiently flexible and configurable, such that it may be utilized (and navigated) in ways other than that shown in the accompanying figures.

Although example aspects of this invention have been described in certain specific embodiments, many additional modifications and variations would be apparent to those skilled in the art. It is therefore to be understood that this invention may be practiced otherwise than as specifically described. Thus, the present example embodiments of the invention should be considered in all respects as illustrative and not restrictive.

What is claimed is:

1. A method for capturing communicated information across a network that includes a plurality of nodes, the method comprising:
providing criteria for capturing, in at least a first one of the nodes, information included in at least one communication passing through the at least one first node;
capturing, from the at least one communication passing through the at least one first node, information meeting the criteria; and
providing the information captured in the capturing to at least a second one of the nodes of the network.

2. A method as set forth in claim 1, wherein the at least one first node includes one of an Optical Network Terminal (ONT), a Remote Terminal (RT), an Optical Line Terminal (OLT), and a Network Terminal (NT).

3. A method as set forth in claim 1, wherein the at least one second node includes an Element Management System (EMS).

4. A method as set forth in claim 1, wherein the at least one second node includes an Optical Line Terminal (OLT).

5. A method as set forth in claim 4, further comprising providing the information from the OLT to an EMS.

6. A method as set forth in claim 1, further comprising presenting the information to a user.

7. A method as set forth in claim 6, wherein the presenting includes presenting the information in a decomposed, interpretable format.

8. A method as set forth in claim 1, wherein the capturing is performed periodically.

9. A method as set forth in claim 1, wherein the providing of the information includes providing the information to the at least one second node by way of at least one third node of the network.

10. A method as set forth in claim 9, wherein the at least one third node includes an OLT.

11. A method as set forth in claim 1, wherein the providing of the criteria includes providing the criteria from an EMS to the at least one first node.

12. A method as set forth in claim 1, wherein the providing of the criteria includes providing the criteria to the at least one first node by way of at least one third node of the communication network.

13. A method as set forth in claim 12, wherein the at least one third node includes an OLT.

14. A method as set forth in claim 1, wherein the information includes information captured at Layer 2 or Layer 3 level.

15. A method as set forth in claim 14, wherein the information includes at least one of Ethernet, ATM, or Frame Relay information.

16. A method as set forth in claim 15, further comprising capturing a predetermined number of most recently received frames at the at least one first node.

17. A method as set forth in claim 1, further comprising providing a time stamp indicating a time at which the capturing occurs.

18. A method as set forth in claim 1, wherein the criteria includes at least one of criteria for triggering the capturing of the information and criteria specifying content of information to be captured.

19. A method as set forth in claim 1, wherein the criteria specifies at least one triggering event or condition, wherein the method further comprises detecting the at least one triggering event or condition, and wherein the capturing of the information is performed in response to the detecting.

20. A method as set forth in claim 1, wherein the criteria includes plural criteria for plural capturing stages, and the capturing includes capturing information meeting respective ones of the criteria in respective ones of the capturing stages.

21. A communication node operating in a communication network, the communication node comprising:
a communication interface coupled to the communication network;
a storage device arranged to store program instructions; and
a processor, coupled to the communication interface and the storage device, and operating under the control of the program instructions to communicate with the network through the communication interface,
wherein the storage device also is arranged to store criteria for capturing information included in communications communicated with the network, and the processor also operates under the control of the program instructions to (a) capture, from the communications, information that meets the criteria, and (b) provide the information to at least one other communication node of the network through the communication interface.

22. A communication node as set forth in claim 21, wherein the communication node is one of an Optical Network Terminal (ONT), an Optical Line Terminal (OLT), a Remote Terminal (RT), and a Network Terminal (NT).

23. A communication node as set forth in claim 21, wherein the at least one other communication node is an Element Management System (EMS).

24. A communication node as set forth in claim 21, wherein the at least one other communication node is an Optical Line Terminal (OLT).

25. A communication node as set forth in claim 21, wherein the processor also operates under the control of the program instructions to receive the criteria from the communication network through the communication interface, and to store the criteria in the storage device.

26. A communication node as set forth in claim 21, wherein the information includes at least one of Ethernet, ATM, and Frame Relay information.

27. A communication node as set forth in claim 21, wherein the criteria includes at least one of criteria for triggering the capture of the information and criteria specifying content of information to be captured.

28. A communication system, comprising:
a plurality of communication nodes arranged to exchange communications with each other, the plurality of communication nodes including
a first communication node, arranged to (a) store criteria for capturing information included in the communications, (b) capture, from the communications, information meeting the criteria, and (c) provide the information through the communication network, and
a second communication node, arranged to receive the information from the first communication node through the network.

29. A communication system as set forth in claim 28, wherein the first communication node includes one of an Optical Network Terminal (ONT), an Optical Line Terminal (OLT), a Remote Terminal (RT), and a Network Terminal (NT).

30. A communication system as set forth in claim 28, wherein the second communication node includes an Element Management System (EMS).

31. A communication system as set forth in claim 28, wherein the second communication node includes an OLT.

32. A communication system as set forth in claim 30, wherein the plurality of communication nodes also include an OLT interposed between the first and second communication nodes, and arranged to receive the information from the first communication node and to forward the information to the second communication node.

33. A communication system as set forth in claim 30, wherein the EMS also is arranged to present the information through a user-perceptible interface.

34. A communication system as set forth in claim 33, wherein the information is presented in a decomposed, interpretable format.

35. A communication system as set forth in claim 28, wherein the second communication node is further arranged to provide the criteria to the first communication node for storage therein.

36. A communication system as set forth in claim 35, wherein the second communication node includes an OLT.

37. A communication system as set forth in claim 35, wherein the second communication node includes an EMS.

38. A communication system as set forth in claim 28, wherein the information is captured at a Layer 2 or Layer 3 level.

39. A communication system as set forth in claim 28, wherein the criteria includes at least one of criteria for triggering the capture of the information and criteria specifying content of information to be captured.

40. A communication system as set forth in claim 39, wherein the first communication node is further arranged to detect an event or condition specified by the criteria for triggering capture of the information.
